(19) United States
(12) Patent Application Publication
(10) Pub. No.: US 2011/0137646 A1
(43) Pub. Date: Jun. 9, 2011

(54) Noise Suppression Method and Apparatus

(75) Inventors: Per Ahgren, Knivsta (SE); Anders Eriksson, Uppsala (SE)

(73) Assignee: TELEFONAKTIEBOLAGET L M ERICSSON

(21) Appl. No.: 12/808,463

(22) PCT Filed: Dec. 20, 2007
(86) PCT No.: PCT/SE2007/051061

§ 371 Date: Jun. 16, 2010

(51) Int. Cl. G10L 21/02

(52) U.S. Cl. 704/226; 704/E21.002

(57) ABSTRACT

The present invention relates to a method and a filter design apparatus for designing a digital filter arrangement for noise suppression of a signal representing an acoustic recording. The method comprises determining a desired frequency response of the digital filter arrangement. The method is characterised by including a combination of a high pass filter and a noise suppression filter in the filter arrangement. The combination of the high pass filter and the noise suppression filter is selected based on the determined desired frequency response.

### TECHNICAL FIELD

The present invention relates to the field of digital filter design. In particular, the invention relates to the field of the design of digital filters for noise suppression in signals representing acoustic recordings.

### BACKGROUND

Due to the ubiquitous presence of noise in natural environments, real-world sound recordings typically contain noise from various sources. In order to improve the sound quality of sound recordings, a range of methods for reducing the noise level of sound recordings have been developed. Often, in such methods, a time-domain noise suppression filter is computed from a desired frequency response, and the time-domain noise suppression filter is then applied to the sound recording. Spectral subtraction is an often used method of suppressing noise in acoustic recordings. In “Low-distortion spectral subtraction for speech enhancement”, Peter Händel, Conference Proceedings of Eurospeech, pp. 1549-1553, ISSN 1018-4074, 1995, different aspects of spectral subtraction methods for suppressing noise are discussed.

The quality of the filtered sound recording may be improved by increasing the length of the time-domain noise suppression filter used. However, the longer the time-domain noise suppression filter, the more computations are required. This is particularly problematic in real-time applications such as telephony. In real-time applications, the filtering has to be performed very fast, and hence, a computationally demanding filter requires high processing powers. Faster processors are more expensive and are generally more energy consuming. Hence, there is a need to improve the quality of noise suppression in sound recordings in a manner that does not affect the computational power requirement.

### SUMMARY

A problem to which the present invention relates is the problem of how to avoid time-dependent fluctuations of the noise attenuation at low frequencies in acoustic recordings. This problem is addressed by a method of designing a digital filter arrangement for noise suppression of a signal representing an acoustic recording. The method comprises determining a desired frequency response of the digital filter arrangement. The method further comprises including, in the filter arrangement, a combination of a high pass filter and a noise suppression filter. The combination of the high pass filter and the noise suppression filter is selected based on the determined desired frequency response.

The problem is further addressed by a digital filter design apparatus arranged to design a digital filter arrangement for noise suppression of a signal representing an acoustic recording. The digital filter design apparatus comprises: a noise suppression filter design apparatus arranged to select a noise suppression filter based on a desired frequency response; and a high pass filter design apparatus arranged to select a high pass filter to be applied in cascade with the noise suppression filter.

The problem is also addressed by a digital filter arrangement and a computer program product for designing a digital filter arrangement.

By the invention is achieved that efficient suppression of low frequency noise can be achieved with limited computational power, and hence that fluctuations of the noise suppression at low frequencies can be avoided or reduced.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic illustration of a noise suppression filter design apparatus according to the prior art.

FIG. 2a is a graph illustrating a desired frequency response at a point in time when speech is present in a signal representing an acoustic recording, and a realised frequency response obtained for this point in time by means of a conventional noise suppression filter.

FIG. 2b is a graph illustrating a desired frequency response at a point in time when no speech is present in a signal representing an acoustic recording, and a realised frequency response obtained for this point in time by means of a conventional noise suppression filter.

FIG. 3 is a flowchart schematically illustrating a method of designing a filter arrangement according to the invention.

FIG. 4 is a flowchart schematically illustrating a method of selecting a high pass filter to be included in a filter arrangement.

FIG. 5 schematically illustrates an embodiment of an inventive filter design apparatus.

FIG. 6a schematically illustrates another embodiment of an inventive filter design apparatus.

FIG. 6b schematically illustrates yet another embodiment of an inventive filter design apparatus.

FIG. 7 is a graph illustrating the scenario of FIG. 2a, where the frequency response of a filter arrangement according to the invention has been included in the graph.

FIG. 8 is a schematic illustration of a user equipment incorporating a digital filter design apparatus according to the invention.

### DETAILED DESCRIPTION

A noisy speech signal y(t) having a desired speech component s(t) and a noise component n(t) may be denoted:

y(t)=s(t)+n(t) (1).

In many situations, it is desirable to suppress the noise component n(t) and form an estimate ŝ(t) of the speech component in a manner so that the estimated speech component ŝ(t) as closely as possible resembles the speech component s(t). One way of doing this is to filter the noisy signal y(t) with a time-domain noise suppression filter h(z), which is designed to remove as much of the noise component n(t) as possible, while retaining as much of the speech component s(t) as possible.

The noise suppression filter h(z) is usually computed from a desired frequency response H(ω), where H(ω) is a real-valued function that is typically designed so that H(ω) is close to zero for frequencies ω at which y(t) only contains noise, H(ω)=1 for frequencies ω at which y(t) only contains speech, and 0<H(ω)<1 for frequencies ω at which y(t) contains noisy speech.

When determining the speech component of a noisy signal, a linear transform F[•] is often applied to frames of samples of the noisy signal. By assuming the following relation:

F[ŝ(t)]=H(ω)F[y(t)] (2)

where F[•] denotes a linear transform such as the Fast Fourier Transform (FFT), the noise suppression filter h(z) can be obtained as the inverse linear transform F⁻¹[ ] of the desired frequency response H(ω). Thus, the speech component estimate ŝ(t) can be obtained by:

ŝ(t)=F⁻¹[H(ω)] [symbol] y(t)=h(z) [symbol] y(t) (3)

where [symbol] denotes convolution.

Hence, in order to arrive at a speech component estimate ŝ(t) from expression (3), the desired frequency response H(ω) needs to be determined. As mentioned above, 0<H(ω)<1 for frequencies ω at which y(t) contains noisy speech. For such frequencies, the particular value chosen for H(ω) at a particular frequency is often chosen in dependence of the Signal-to-Noise Ratio (SNR) of the noisy speech signal y(t) at that frequency.

The desired frequency response H(ω) can be estimated by means of various methods, a typical method being spectral subtraction (for a description on how to obtain H(ω) by spectral subtraction, see for example “Low-distortion spectral subtraction for speech enhancement”, Peter Händel, Conference Proceedings of Eurospeech, pp. 1549-1553, ISSN 1018-4074, 1995). Since the SNR of the noisy speech signal y(t) at a particular frequency varies with time, the desired frequency response H(ω) is generally updated over time—typically, the desired frequency response H(ω) is updated for each frame of data. Hence, the desired frequency response H(ω) typically varies between frames, so that H(kₙ,ω)≠H(kₙ₊₁,ω, where kₙ denotes the timing of a frame having frame number n. Alternatively, the desired frequency response H(ω), and hence the filter arrangement determined from the desired frequency response, can be updated at a different time interval. Thus, the desired frequency response and the filter arrangement vary with time. However, in order to simplify the description, this time dependency of H(ω) and h(z) will, in the expressions below, not be explicitly shown.

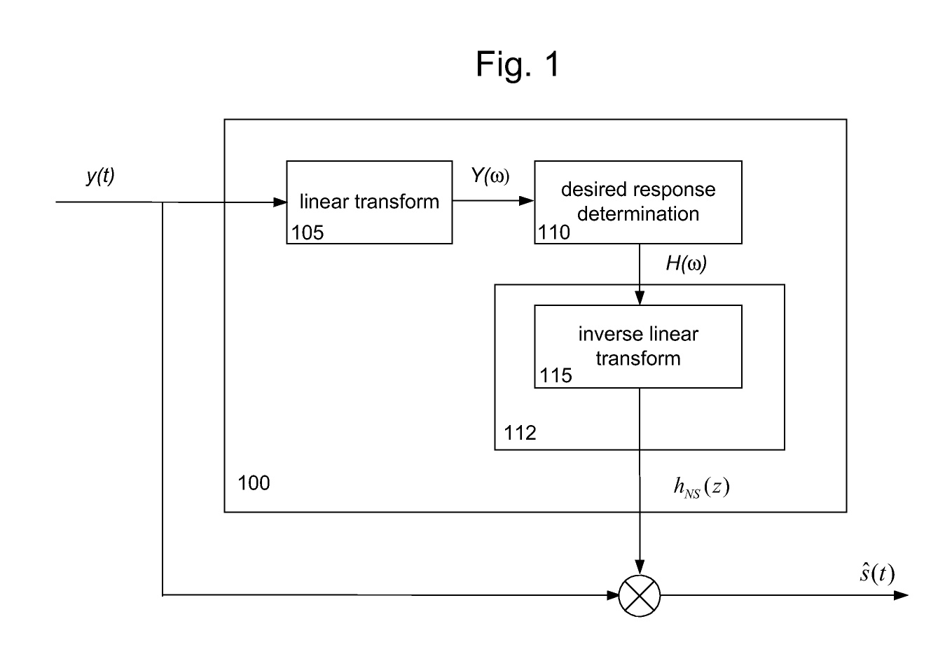

FIG. 1 illustrates a filter design apparatus 100 operating according to the prior art and being arranged to generate an appropriate noise suppression filter h_{NS}(z) based on a received sampled noisy speech signal y(t). Filter design apparatus 100 comprises a linear transform apparatus 105 arranged to receive the sampled noisy speech signal y(t) and to generate the linear transform Y(ω) of the sampled noisy speech signal y(t). Filter design apparatus 100 of FIG. 1 further comprises a desired response determination apparatus 110 arranged to receive the linear transform Y(ω) of the sampled signal y(t) and to determine the desired frequency response H(ω) based on the linear transform Y(ω). Filter design apparatus 100 further comprises a noise suppression filter design apparatus 112 comprising an inverse linear transform apparatus 115 arranged to receive the desired frequency response H(ω) and to generate the inverse linear transform of the desired frequency response H(ω). Generally, the output of the inverse linear transform apparatus 115 is further processed in noise suppression filter design apparatus 112, for example in the manner described in U.S. Pat. No. 7,251,271, in order to obtain the noise suppression filter h_{NS}(z). The length of the filter h_{NS}(z) is determined in dependence of such further processing, which will not be described in any further detail here. The output of the noise suppression filter design apparatus 112 is a signal representing the noise suppression filter h_{NS}(z).

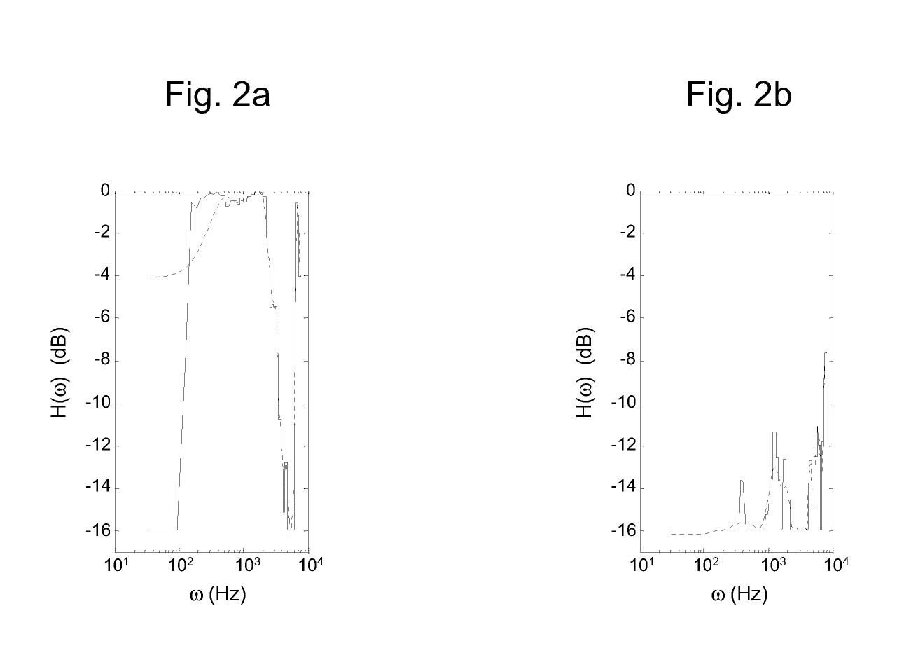

When suppressing noise in speech applications, the desired frequency response H(ω) often includes a sharp transition between low frequencies at which only noise is present, and frequencies at which speech is present together with noise. This is illustrated in FIG. 2, wherein the desired frequency response H(ω) is plotted as a solid line at two different instances in time: FIG. 2a illustrates a point in time, kₘ, where speech is present, while FIG. 2b illustrates a point in time, kₙ, where no speech is present and where the signal y(t) contains the noise component n(t) only. As can be seen, the transition between the high desired suppression at low frequencies and the low desired suppression at higher, speech-containing frequencies in FIG. 2a is very sharp. Such sharp transitions in the frequency response can be obtained by including a large number of coefficients in the realised noise suppression filter h_{NS}(z).

However, by including a large number of coefficients in the realised noise suppression filter h_{NS}(z), the number of computations required when implementing the noise suppression filter will be large. In many applications, this is not feasible due to limited computational capacity, which for example is often the case in real-time applications. The realised frequency response H^{realised}(ω) of a typical realised noise suppression filter h_{NS}(z) is illustrated in FIGS. 2a and 2b as a dotted line. For the time kₘ, where both speech and noise are present, the realised frequency response H^{realised}(ω) is a poor approximation of the desired frequency response H(ω) at low frequencies, whereas for the time kₙ, where only noise is present and the transitions in the desired frequency response H(ω) are much less drastic, the realised frequency response H^{realised}(ω) provides an adequate approximation of the desired frequency response H(ω). A comparison between H^{realised}(ω) at time kₘ, H^{realised} (kₘ,ω) and H^{realised}(ω) at time kₙ, H^{realised} (k,ω), illustrated by the dotted lines in FIGS. 2a and 2b, respectively, shows that the noise level at low frequencies will vary significantly with time if the realised noise suppression filter h_{NS}(z) in the prior art solution does not comprise a sufficient number of coefficients. Such time-dependent fluctuations of the noise suppression is commonly referred to as noise pumping, and will be heard as a shadow voice in the speech component estimate ŝ(t).

Hence, for real-time applications, or in other applications where the computational capacity is limited, there is a desire to find alternative ways of obtaining adequate filtering of a noisy speech signal y(t).

According to the invention, the desired frequency response is obtained by a combination of high pass and noise suppression filters. By applying a high pass filter to the noisy speech signal y(t) in addition to the noise suppression filter h_{NS}(z), the requirements on the noise suppression at low frequencies of the noise suppression filter h_{NS}(z) can be less strict, and a noise suppression filter comprising a lower number of coefficients may be used to obtain a frequency response that is a sufficiently close to the desired frequency response H(ω).

Hence, the total time-domain filter arrangement hₜₒₜₐₗ(z) will, according to the invention, be obtained as

hₜₒₜₐₗ(z)=h_{HP}(z) [symbol] h_{NS}(z) (4)

where h_{HP} is a high pass filter and h_{NS}(z) is a noise suppression filter.

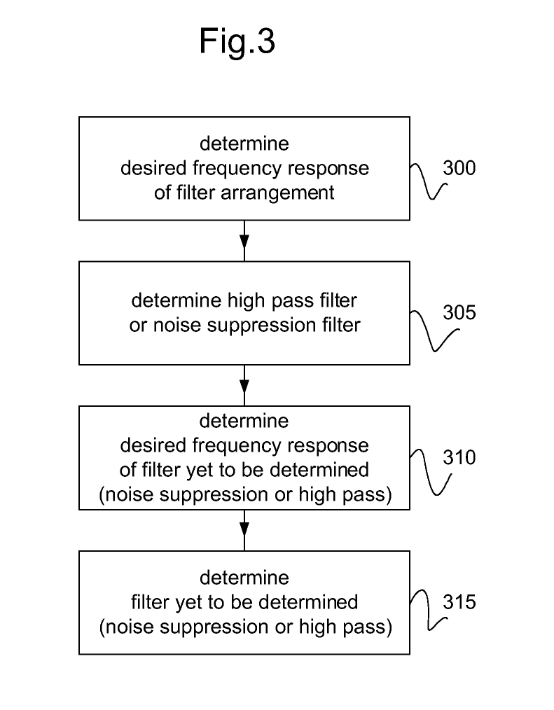

A schematic flowchart illustrating a method of designing a filter arrangement including high pass and noise suppression filters according to the invention is given in FIG. 3. In step 300, a desired frequency response H(ω) of the filter arrangement, which in the following will be referred to as the total desired frequency response Hₜₒₜₐₗ(ω), is determined. In step 305, either a high pass filter, or a noise suppression filter, is determined. In step 310, a desired frequency response is determined for the filter yet to be determined, i.e. the one of a high pass filter and a noise suppression filter, which was not determined in step 305d. The desired frequency response of the filter yet to be determined could advantageously be determined as the residual desired frequency response, i.e. as the part of the total desired frequency response Hₜₒₜₐₗ(ω) which is not obtained by the filter determined in step 305, so that the total realised frequency response obtained from the combination of the high pass and noise suppression filters is as close as possible to the total desired frequency response Hₜₒₜₐₗ(ω):

H_{NS}(ω)H_{HP}(ω)=Hₜₒₜₐₗ(ω) (5)

Step 315 is then entered, wherein the filter yet to be determined is determined.

When the high pass filter h_{HP}(z) is determined in step 305, i.e. prior to the determination of the noise suppression filter, h_{NS}(z), the high pass filter could advantageously be selected based on the total desired frequency response, Hₜₒₜₐₗ(ω). However, in some embodiments of the invention, a pre-determined high pass filter may be used, which is independent of the total desired frequency response Hₜₒₜₐₗ (ω) (in such cases, the determination of the high pass filter h_{HP}(z) can be performed prior to step 300).

As mentioned above, when a high pass filter h_{HP}(z) is determined first, and a noise suppression filter is to be determined in step 315, the frequency response of the selected high pass filter, H_{HP}(ω), is preferably taken into account in accordance with expression (5). However, in some implementations of the invention, it might be sufficient to use the total desired frequency response as the desired frequency response of the noise suppression filter: H_{NS}(ω)=Hₜₒₜₐₗ(ω).

If the noise suppression filter is determined in step 315, the noise suppression filter h_{NS}(z) is determined by applying the inverse linear transform F⁻¹[•] to H_{NS}(ω). If the noise suppression filter is determined in step 305, the noise suppression filter h_{NS}(z) is determined by applying the inverse linear transform F⁻¹[•] to Hₜₒₜₐₗ(ω).

When a high pass filter h_{HP}(z) and a noise suppression filter h_{NS}(z) have been determined in accordance with the filter design method illustrated in FIG. 3, the high pass filter h_{HP}(z) and the noise suppression filter h_{NS}(z) can be applied to the noisy speech signal y(t) in cascade—either the high pass filter h_{HP}(z) is applied first and the noise suppression filter h_{NS}(z) after, or vice versa.

The determination of the filter arrangement comprising a high pass filter h_{HP}(z) and a noise suppression filter h_{HP}(z) would generally be updated over time in order to adjust the filter arrangement to variations in the noisy speech signal y(t). The filter arrangement will in many implementations of the invention be updated every time frame of the noisy speech signal, although any pattern for updating the filter arrangement may be used.

The high pass filter and the noise suppression filter could be determined based on Hₜₒₜₐₗ (ω) in an iterative manner. For example, if a first approximation of the one of the filters is assumed, a first approximation of the other filter can be determined in step 305 in dependence of this first approximation of the first filter. In step 310, the desired frequency response of the first filter is determined, and in step 315, a second approximation of the first filter is determined based on the desired frequency response obtained in step 315. An additional step could be added to the steps shown in FIG. 3, wherein the desired frequency response of the second filter is determined based on the second approximation of the first filter. A second approximation of the second filter could then be determined based on the desired frequency response determined in the additional steps, and so forth. The number of iterations could be selected in accordance with the available computational capacity and the time requirements of the re-play of the acoustic recording.

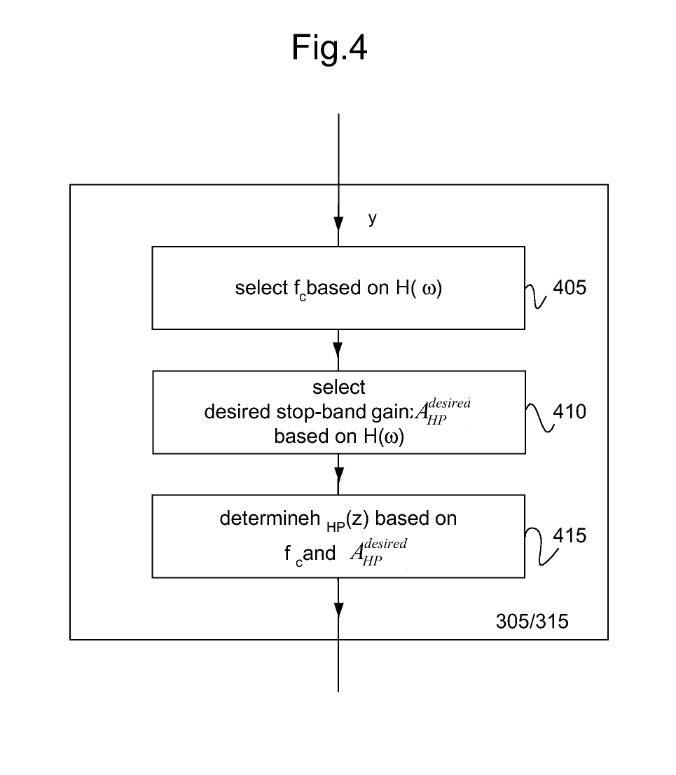

An embodiment of the step of selecting a high pass filter h_{HP}(z) is further illustrated in FIG. 4. The method of FIG. 4 could be seen as a possible implementation of step 305 or 315, depending on in which of these steps the high pass filter h_{HP}(z) is determined. In order to simplify the description, in the embodiment of the invention illustrated by FIG. 4, the high pass filter h_{HP}(z) determined in dependence of the total desired frequency response Hₜₒₜₐₗ(ω), prior to the determination of the noise suppression filter h_{NS}(z). However, as seen in relation to FIG. 3, the noise suppression filter h_{NS}(z) could alternatively be determined prior to the high pass filter h_{HP}(z).

In step 405, a cut-off frequency f_{c} for the high pass filter h_{HP}(z) is selected. The cut-off frequency f_{c} is usually selected as the frequency at which a transition between high and low values of Hₜₒₜₐₗ(ω) occurs, and could be selected by means of any suitable method. For example, the cut-off frequency f_{c} could be determined as:

f_{c}=argmin{Hₜₒₜₐₗ(fₘₐₓ)−2Hₜₒₜₐₗ(f)} (6),

where the frequency fₘₐₓ is the frequency, within a frequency interval f_{L}≦f≦f_{H}, for which the total desired frequency response Hₜₒₜₐₗ(ω) takes its highest value (the frequency interval f_{L}≦f≦f_{H} can typically be the frequency interval of the noisy speech signal).

In step 410, a desired stop band gain A_{HP}^{desired} of the high pass filter k_{HP}(z) is determined. The desired stop band gain A_{HP}^{desired} of the high pass filter can for example be obtained as

$${A}_{HP}^{desired} = \frac{{H}_{total}^{stopband}}{{H}_{NS}^{stopband} {H}_{total}^{passband}} , \qquad ( 7 )$$

where Hₜₒₜₐₗ^{passband} may be obtained as

Hₜₒₜₐₗ^{passband}=Hₜₒₜₐₗ(fₘₐₓ) (8)

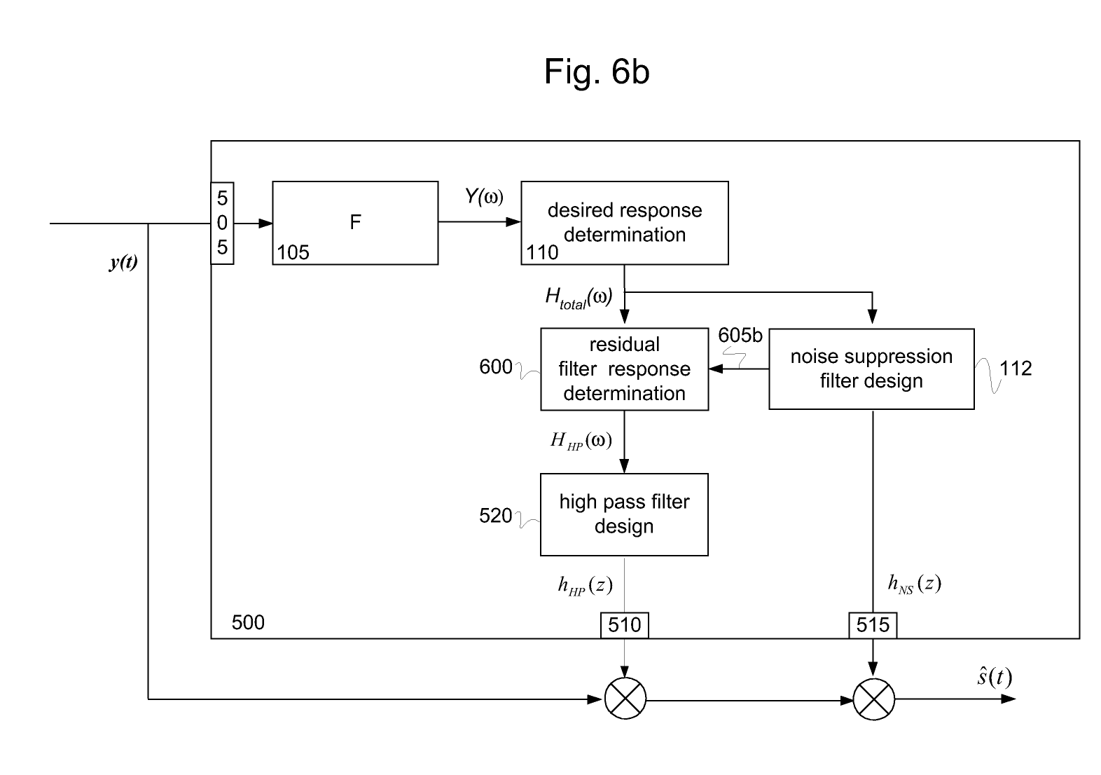

and Hₜₒₜₐₗ^{stopband} may be obtained as

$${H}_{total}^{stopband} = \frac{{H}_{total} ( {f}_{1} ) + {H}_{total} ( {f}_{3} )}{2} , \qquad ( 9 )$$

where f₁ and f₃ have been selected as two suitable low frequencies at which speech is rarely present. In the example illustrated in FIG. 7 (see below), f₁ was set to 63 Hz and f₃ was set to 94 Hz. In this particular example, the sampling frequency was 16 kHz and an FFT of length 512 was used. Hence, f₁=63 Hz and f₃=94 Hz correspond to the 3rd and 4th frequency bins, respectively.

Other ways of defining Hₜₒₜₐₗ^{stopband} may be used, such as for example Hₜₒₜₐₗ^{stopband}=Hₜₒₜₐₗ(f₀) where f₀ is selected as a frequency for which the full stop-band attenuation should be applied.

A pre-determined value, independent of the desired frequency response H(ω), could be used as an estimate of the stop-band response of the noise suppression filter, H_{NS}^{stopband} in expression (7) above.

However, in order to obtain a better result of the noise suppression, a value of the stop-band response provided by the noise suppression filter, H_{NS}^{stopband} can be estimated each time a high pass filter h_{HP}(z) is to be selected. H_{NS}^{stopband} could for example be obtained via studies of the different noise suppression filters h_{NS}(z) obtained for different Hₜₒₜₐₗ(ω). Such studies would preferably have been performed prior to the determination of a high pass filter h_{HP}(z) and the result of such studies would preferably have been stored in a table or as an expression for extrapolating an estimate of H_{NS}^{stopband} from the known Hₜₒₜₐₗ(ω) according to which the noise suppression filter and high pass filter are to be determined. Hence, the estimation of a value of H_{NS}^{stopband} for the purposes of expression (7) could include checking a table or calculating a value via a given expression.

Alternatively, a value of the stop-band response of the noise suppression filter, H_{NS}^{stopband}, could be estimated in an iterative fashion by iterating steps 305-315 at least once. The first time step 305 is entered, the value of H_{NS}^{stopband} could be given an estimated value (for example a pre-determined value). When a noise suppression filter has been determined in step 315 based on this estimated value of H_{NS}^{stopband} step 305 could be re-entered, and the stop-band response obtained by the noise suppression filter determined in step 315 could be used as the estimation of the stop-band response of the noise suppression filter H_{NS}^{stopband} of step 305. Or, step 310 of FIG. 3 could be performed prior to step 305, so that a value of H_{NS}^{stopband} has already been obtained as step 305 is entered. Step 310 could then be re-entered after step 305 has been performed, with a value of H_{NS}(ω) that takes the frequency response of the high pass filter into account. The iterative procedure for determining the high pass filter and the noise suppression filter could for example be suitable in situations where the high pass filter does not have to be updated every time frame, or in situations where the filtering of the acoustic recording is performed prior to play-back of the recording.

In step 415, high pass filter h_{HP}(z) is determined in dependence of the determined cut-off frequency f_{c} and the desired stop-band gain A_{HP}^{desired}.

The high pass filter employed could advantageously be an Infinite Impulse Response (IIR) filter, since the number of coefficients required for an IIR filter is generally lower than the number of coefficients required for a Finite Impulse Response (FIR) filter of similar characteristics. An example of a prior art high pass filter type that can advantageously be used in the invention is the 1^{st} order Butterworth filter. The Butterworth filters are advantageous for the purposes of the invention since these filters are designed to have a flat frequency response in the passband, and would hence give a minimal distortion of a possible speech component s(t) present in the passband. 1^{st} order Butterworth filters provide a sufficiently sharp transition from the pass-band to the stop-band and are computationally simple to implement. However, other types of high pass filters may alternatively be employed, such as for example Butterworth filters of high order or Chebyshev filters. Combinations of two or more high pass filters could also be employed.

In step 415, the filter coefficients of the employed high pass filter type employed are determined in a conventional manner based on the value of the cut-off frequency f_{c}. The time-domain filter defined by these coefficients will in the following be denoted h_{HP}^{unlimited}(z) since the low-frequency attenuation is unlimited in comparison to the desired high pass filter h_{HP}(z).

In order to obtain a time-domain filter showing the desired stop-band gain, the high pass filter h_{HP}(z) can be determined as

h_{HP}(z)=(1−α)+α(h_{HP}^{unlimited}(z)) (10)

such that the stop-band gain of h^{HP}(z) will be as close as possible to the desired stop-band gain A_{HP}^{desired}. α is a coefficient for which the value lies between 0 and 1. A value of α could for example be given as the value of a which minimises the following expression:

∥H_{HP}(f₂)|−A_{HP}^{desired}| (11)

where |H_{HP}(f₂)| is the value of the frequency response H_{HP}(ω) of h_{HP}(z) according to expression (10) at a frequency f₂. f₂ could preferably be selected as a frequency well into the stop-band of the high pass filter h_{HP}(z). For example, f₂ could be selected as a frequency lying in the middle of the frequency interval defined by the frequencies f₁ and f₃ referred to above.

The method of determining a suitable high pass filter described in FIG. 4 could be varied in many ways. For example, upon updating of the filter arrangement, a check could be introduced as to whether or not it would be suitable to include a high pass filter h_{HP}(z) in the updated instance of the filter arrangement, since at some moments in time, it might be computationally simpler to obtain a close approximation of the total desired frequency response Hₜₒₜₐₗ(ω) by means of a noise suppression filter h_{NS}(z), without the use of any high pass filter h_{HP}(z). For example, if there is no speech component s(t) present in the noisy speech signal y(t), it might be computationally more simple to apply only a noise suppression filter h_{NS}(z) than to apply both a high pass filter h_{HP}(z) and a noise suppression filter h_{NS}(z). Such a check could for example be based on the sharpness of a transition between high desired attenuation and low desired attenuation in the total desired frequency response Hₜₒₜₐₗ(ω)—if a sharp transition is desired, then it would generally be suitable to apply a high pass filter h_{HP}(z). Alternatively, such analysis could include checking whether the noisy speech signal y(t) includes a speech component s(t)—for example, if no speech component is present at a particular point in time, it would be advantageous to implement the filter arrangement for this point in time without the use of any high pass filter h_{HP}(z).

An alternative way of determining whether the application of a high pass filter would be beneficial could be to check whether the cut-off frequency f_{c}, obtained via expression (6) or in any other way, lies within a frequency interval f_{c}^{min}≦f≦f_{c}^{max}. This frequency interval can be referred to as the high pass filter frequency interval, where the high pass filter frequency interval is chosen so that if the cut-off frequency lies within the high pass filter frequency interval, then a high pass filter h_{HP}(z) should be applied to the noisy speech signal y(t).

A yet further way of determining whether a high pass filter would be beneficial could be to perform analysis of the desired high pass stop-band gain A_{HP}^{desired} obtained in step 410, or of the coefficient α. An analysis of the desired stop-band gain A_{HP}^{desired}, or α, of the high-pass filter could for example include a check as to whether A_{HP}^{desired} (α) exceeds (or α is lower than) a particular threshold value, such as for example −3 dB for A_{HP}^{desired} and 0.5 for α. If the desired gain A_{HP}^{desired} in the stop-band exceeds the threshold value (or if α is lower than the α-threshold), then it may be concluded that the desired gain is low enough to be efficiently obtained by the noise suppression filter h_{NS}(z).

The above mentioned ways of analysing whether a high pass filter should be included in a particular instance of the filter arrangement could be used in any combination, or only one way (or none) could be implemented on its own. If it is found in such analysis that no high pass filter should be included in the filter arrangement, the high pass filter could for example be set to 1: h_{HP}(z)=1, or the high pass filter component h_{HP}(z) of the filter arrangement could simply be omitted.

The method illustrated in FIG. 4 of selecting a high pass filter could be used for determining a constant high pass filter that is used for all time frames of y(t), or could be repeated from time to time, for example upon every new time frame.

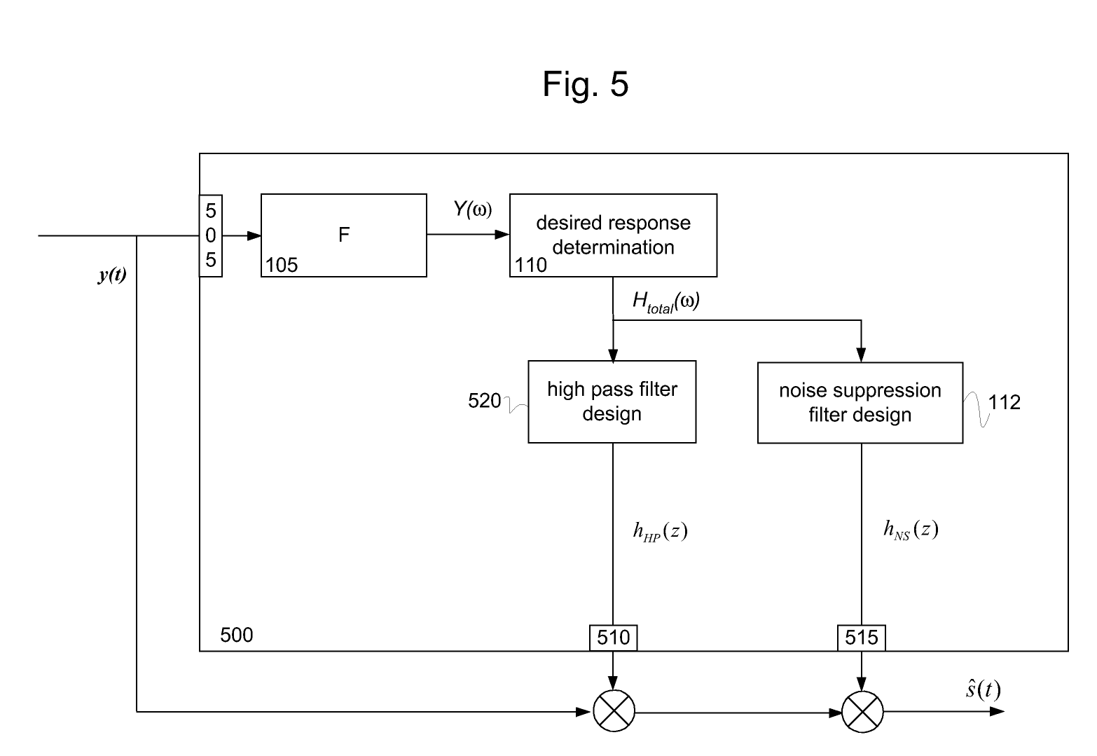

In FIG. 5, a filter design apparatus 500 operating according to the invention is schematically illustrated. Filter design apparatus 500 has an input 505 for receiving a noisy speech signal y(t) to be filtered, an output 510 for outputting a signal representing a high pass filter h_{HP}(z) and an output 515 for outputting a signal representing a noise suppression filter h_{NS}(z). The input 505 is connected to a linear transform apparatus 105 arranged to receive the sampled noisy speech signal y(t) and to generate the linear transform Y(ω) of the sampled noisy speech signal y(t). Filter design apparatus 500 further comprises a desired response determination apparatus 110 arranged to receive a signal indicative of the linear transform Y(ω) of the sampled signal y(t) and to determine the total desired frequency response, Hₜₒₜₐₗ(ω) based on the linear transform Y(ω).

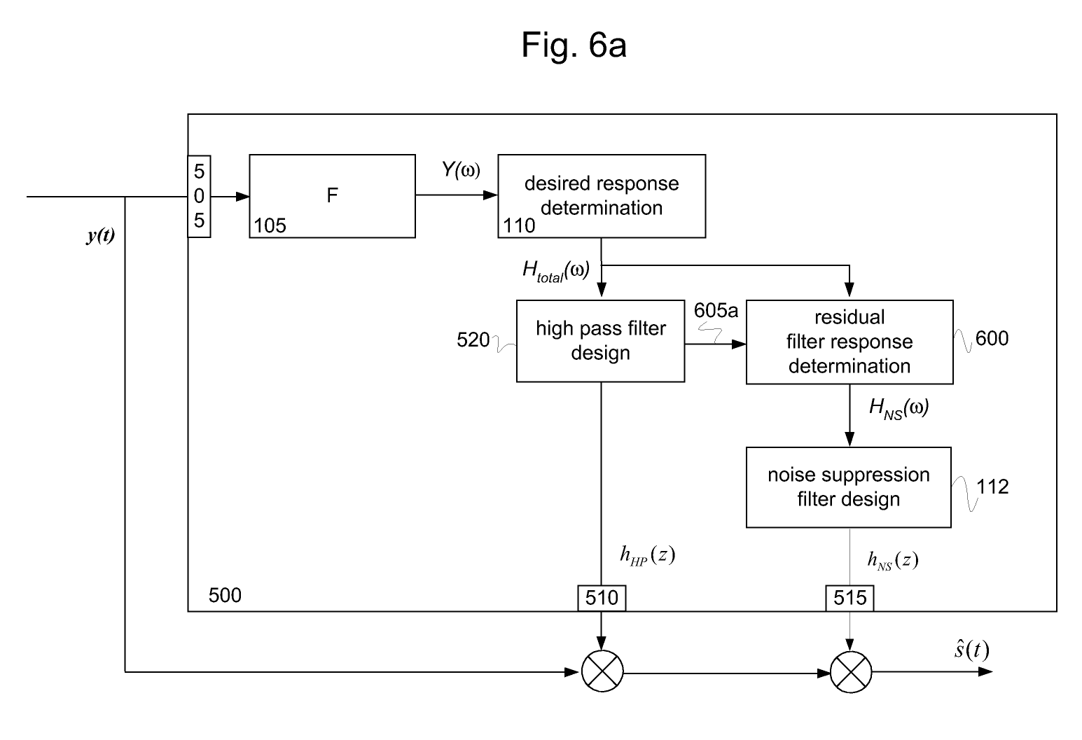

The inventive filter design apparatus 500 further comprises a high pass filter design apparatus 520 and a noise suppression filter design apparatus 112 (cf. FIG. 1). The high pass filter design apparatus 520 is arranged to design a high pass filter h_{HP}(z) for suppression of the low frequency part of the noise component n(t). The filter design apparatus 500 of FIG. 5 is arranged to design the high pass filter h_{HP}(z) and the noise suppression filter h_{NS}(z) independently of each other. As will be seen in relation to FIG. 6, the filter arrangement designed by filter design apparatus 500 may be further improved by using information about the noise suppression filter h_{NS}(z) when designing the high pass filter h_{HP}(z) and/or by using information about the high pass filter h_{HP}(z) when designing the noise suppression filter h_{NS}(z).

The high pass filter design apparatus 520 could for example be arranged to operate according to the method illustrated by the flowchart in FIG. 4, wherein the total desired frequency response is taken into account when designing the high pass filter h_{HP}(z).

In implementations of the invention where one or both of the filter design apparatuses 520 and 112 use the result of the filter design of the other filter design apparatus into account in the filter design, filter design apparatus 500 could advantageously comprise a residual frequency response determination apparatus, arranged to determine the part of the total desired filter response Hₜₒₜₐₗ(ω) that is yet to be provided once one of the filter design apparatuses 520 or 112 has generated a filter. In FIGS. 6a and 6b, embodiments of this aspect of the invention are illustrated.

FIGS. 6a illustrates an embodiment of the filter design apparatus 500 wherein the high pass filter design apparatus 520 is initiated prior to the initiation of the noise suppression filter design apparatus 112. In this embodiment, filter design apparatus 500 further comprises a residual frequency response determination apparatus 600, arranged to determine the part of the total desired frequency response Hₜₒₜₐₗ(ω) that should be provided by the noise suppression filter h_{NS}(z). This part is referred to as the desired noise suppression frequency response, H_{NS}(ω). Residual frequency response determination apparatus 600 of FIG. 6a is arranged to receive information from the desired response determination apparatus 110, as well as from the high pass filter design apparatus 520. Residual frequency response determination apparatus 600 is furthermore arranged to convey a signal indicative of the desired noise suppression filter frequency response, H_{NS}(ω), to the noise suppression filter design apparatus 112.

The high pass filter design apparatus 520 of FIG. 6a is arranged to receive a signal indicative of the total desired frequency response Hₜₒₜₐₗ(ω), and to generate a high pass filter h_{HP}(z) in response to this Hₜₒₜₐₗ(ω)-signal. However, the high pass filter design apparatus 520 is further arranged to convey a frequency response portion signal 605a to the residual frequency response determination apparatus 600. The frequency response portion signal 605a is indicative of a part of the total frequency response Hₜₒₜₐₗ(ω) that is provided by the high pass filter h_{HP}(z). The frequency response portion signal 605a could advantageously include information on the high pass filter h_{HP}(z), or information on the realised frequency response of the high pass filter, H_{HP}^{realised}(ω).

Another embodiment of the invention is illustrated in FIG. 6b, wherein the noise suppression filter design apparatus 112 is initiated prior to the initiation of the high pass filter design apparatus 520. In this embodiment, a residual frequency response determination apparatus 600 is arranged to determine the part of the total desired frequency response Hₜₒₜₐₗ(ω) that should be provided by the high pass filter h^{HP}(z). This part is referred to as the desired high pass frequency response, H_{HP}(ω). Residual frequency response determination apparatus 600 of FIG. 6b is arranged to receive information from the desired response determination apparatus 110, as well as from the noise suppression filter design apparatus 112. Residual frequency response determination apparatus 600 of FIG. 6b is furthermore arranged to convey a signal indicative of the desired high pass filter frequency response, H_{HP}(ω), to the high pass filter design apparatus 520.

In the embodiment of FIG. 6b, the noise suppression filter design apparatus 112 is arranged to convey a frequency response portion signal 605b to the residual frequency response determination apparatus 600. The frequency response portion signal 605b is indicative of a part of the total frequency response Hₜₒₜₐₗ(ω) that is provided by the noise suppression filter h_{NS}(z). The frequency response portion signal 605b could advantageously include information on a noise suppression filter h_{NS}(z) determined by the noise suppression filter design apparatus 112, or information on the realised frequency response of the noise suppression filter, H_{NS}^{realised}(ω).

The residual desired frequency response apparatus 600 of FIGS. 6a and 6b is arranged to determine the residual desired frequency response, H_{NS}(ω) or H_{HP}(ω), based on the total desired frequency response Hₜₒₜₐₗ(ω) and a frequency response portion signal 605a or 605b. When the frequency response portion signal 605 carries information on a frequency response obtained by the already determined filter (high pass filter or noise suppression filter, depending on which filter has already been determined), the residual desired frequency response H_{NS}(ω) or H_{HP}(ω) can be obtained via expression (5). In implementations of this embodiment of the invention where the frequency response portion signal 605a and 605b carries information about the actual time-domain filter that has already been determined, h_{HP}(z) or h_{NS}(z), then the linear transform F[•] is preferably applied to the filter response portion signal 605 in order to obtain the frequency response of the already determined filter, and the residual desired frequency response is then determined according to expression (5).

In the various embodiments of the filter design apparatus 500 illustrated in FIGS. 5, 6a, the high pass filter design apparatus 520 is arranged to receive a signal indicative of the total desired frequency response Hₜₒₜₐₗ(ω), either directly or indirectly (e.g. via a signal indicative of the frequency response of the selected noise suppression filter). However, in implementations of the invention where the same high pass filter h_{HP}(z) is applied to all instances of the noisy speech signal y(t), the high pass filter design apparatus 520 does not need any information indicative of the desired frequency response Hₜₒₜₐₗ(ω), and no connection is necessary between the desired response determination apparatus 110 and the high pass filter design apparatus 520, or between the high pass filter design apparatus 520 and the noise suppression filter design apparatus 112.

When the filter response portion signal 605a or 605b carry information on the determined filter h_{HP}(z) or h_{HP}(z), the filter response signal portion 605a or 605b may be tapped from the filter signal output from the high pass filter design apparatus or the noise suppression filter design apparatus, respectively. Alternatively, the filter response portion signal 605 may be signalled from a separate output.

When a high pass filter h_{HP}(z) and a noise suppression filter h_{NP}(z) have been determined by the filter design apparatus 500, the filters may be output via outputs 510 and 515, respectively, and applied in cascade to the noisy speech signal y(t).

A filter design apparatus 500 may include a high pass filter benefit evaluation apparatus (not shown), arranged to determine whether the application of a high pass filter would be beneficiary, as discussed above in relation to FIG. 4. Filter design apparatus 500 may further include other components such as buffers etc.

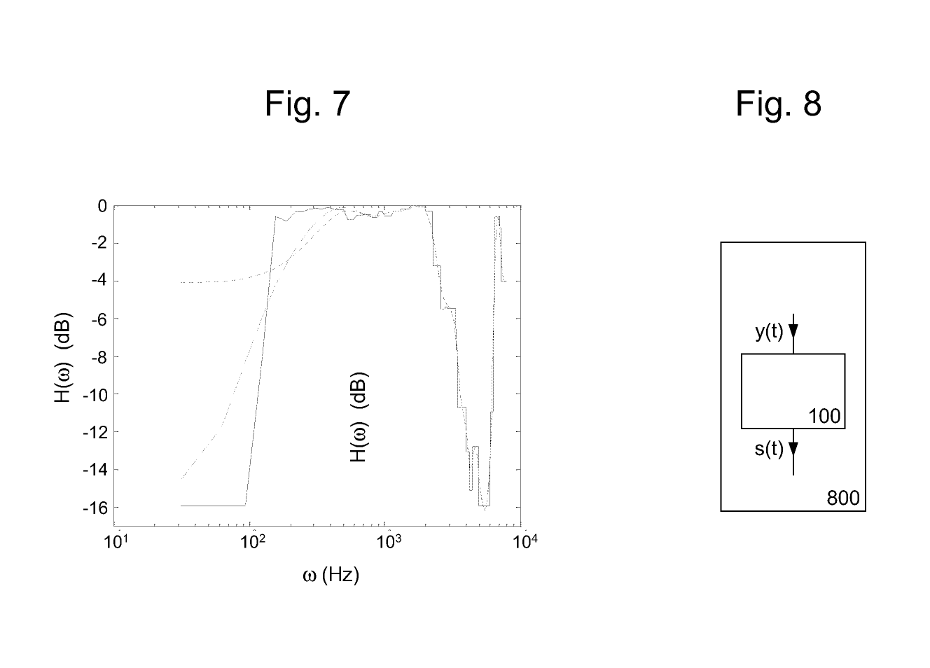

The filter design apparatus 500 can advantageously be implemented by suitable computer software and/or hardware. The filter design apparatus 500 can advantageously be implemented in user equipments for transmission of speech, such as mobile telephones, fixed line telephones, walkie-talkies etc. The filter design apparatus may furthermore be implemented in other types of user equipments where acoustic signals are processed, such as cam-corders, dictaphones, etc. In FIG. 8, a user equipment 800 comprising a filter design apparatus according to the invention is shown. A user equipment 800 could be arranged to perform noise suppression in accordance with the invention upon recording of an acoustic signal, and/or upon re-play of an acoustic signal that has been recorded at a different time and/or by a different user equipment. The filter design apparatus 500 also be implemented in other devices, such as for example in nodes in a communications network.

The invention allows for an efficient noise reduction at low frequencies with maintained performance at higher frequencies. Since the human ear is very sensitive to low frequencies, the experienced improvement is great when low frequent noise can be suppressed in an efficient manner. The invention is particularly applicable to noisy speech recordings. Speech rarely includes frequency components at the lowest frequencies, so noise at these low frequencies can be suppressed without introducing disturbances in the desired speech signal. However, the invention can also advantageously be applied for noise suppression in other types of acoustic recordings. The signal y(t) in which the noise is to be suppressed is in the above referred to as a noisy speech signal, but could be any type of noisy acoustic recording.

Since a combinatory use of a high pass filter h_{HP}(z) and a noise suppression filter h_{NS}(z) greatly reduces the need for a sharp transition in the frequency response H_{NS}(ω) of the noise suppression filter h_{NS}(z), as compared to a conventional noise suppression filter arrangement, a noise suppression filter h_{NS}(z) having a significantly reduced number of filter coefficients can be used while obtaining the same result as obtained with a longer, conventional noise suppression filter. The high pass filter h_{HP}(z) can be realised by means of an IIR filter having far fewer filter coefficients than the difference in number of coefficients of the noise suppression filter of the inventive arrangement and a conventional noise suppression filter by which a similar total frequency response may be obtained. Hence, the total number of filter coefficients required for obtaining a similar noise suppression result can be lowered, and hence, the computational power required in order to achieve the noise suppression can be reduced. Alternatively, the noise suppression obtained by the same computation power can be greatly enhanced. This is illustrated in FIG. 7, in which the invention has been applied to the scenario illustrated in FIG. 2a. The desired frequency response is illustrated by the solid curve, the frequency response realised by a conventional noise suppression filter is illustrated by the dotted curve, and the frequency response realised by means of a filter arrangement according to the invention is illustrated by the dashed curve. The number of filter coefficients used in the conventional noise suppression filter is the same as the number of filter coefficients used in the noise suppression filter h_{NS}(z) of the filter arrangement according to the invention. As can be seen in the graph of FIG. 7, the noise suppression obtained with the inventive filter arrangement is much better than that of a conventional noise suppression filter at low frequencies. At higher frequencies, the emulation of the desired frequency response of the inventive arrangement is just as good, or better, than that of a conventional noise suppression filter arrangement.

Since the computational power required in order to achieve a desired noise suppression can be substantially reduced by means of the invention, the invention is particularly advantageous in real-time applications such as telephony. However, the invention is equally applicable to applications where the acoustic recording may be stored and processed at a later time.

One skilled in the art will appreciate that the present invention is not limited to the embodiments disclosed in the accompanying drawings and the foregoing detailed description, which are presented for purposes of illustration only, but it can be implemented in a number of different ways, and it is defined by the following claims.

1. A method of designing a digital filter arrangement for noise suppression of a signal (y(t)) representing an acoustic recording, the method comprising;
determining a desired frequency response (Hₜₒₜₐₗ(ω)) of the digital filter arrangement;
including, in the filter arrangement, a high pass filter (h_{HP}(z)) and a noise suppression (h_{NS}(z)) filter, wherein one of the high pass filter and the noise suppression filter is selected based on the determined desired frequency response and the other one of the high pass filter and the noise suppression filter is selected to be applied to the signal in cascade with said one of the high pass filter and the noise suppression filter selected based on the determined desired frequency response.

2. The method of claim 1, wherein the high pass filter is selected based on the desired frequency response.

3. The method of claim 1, further comprising:
selecting the high pass filter prior to selecting the noise suppression filter;
determining an estimate of the residual desired frequency response; and
selecting the noise suppression filter based on the estimate of the residual desired frequency response.

4. The method of claim 1, wherein an estimation of the response of the noise suppression filter in the stop band of the high pass filter is taken into account when selecting the high pass filter.

5. The method of claim 1, further comprising:
selecting the noise suppression filter prior to selecting the high pass filter;
determining an estimate of the residual desired frequency response; and selecting the high pass filter based on the estimate of the residual desired frequency response.

6. The method of claim 1, further comprising:
updating the desired frequency response and the filter arrangement on a regular basis.

7. The method of claim 6, further comprising:
checking whether a particular instance of the desired frequency response is such that the usage of a high pass filter in the filter arrangement would be beneficial; and
if the usage of a high pass filter would not be beneficial, realizing the filter arrangement in a manner so that no high pass filter is included for this particular instance.

8. A digital filter design apparatus arranged to design a digital filter arrangement for noise suppression of a signal (y(t)) representing an acoustic recording, the digital filter design apparatus comprising:
a noise suppression filter design apparatus arranged to select a noise suppression filter based on a first desired frequency response (Hₜₒₜₐₗ(ω); H_{NS}(ω)); and
a high pass filter design apparatus arranged to select a high pass filter (h_{HP}(z)) to be applied to the signal in cascade with the noise suppression filter (h_{NS}(z)).

9. The digital filter design apparatus of claim 8, wherein the high pass filter design apparatus is arranged to select a high pass filter based on a second desired frequency response (Hₜₒₜₐₗ(ω); H_{HP}(ω).

10. The digital filter design apparatus of claim 8, further comprising
means for determining whether or not a high pass filter shall be selected for noise suppression of a particular instance of the signal.

11. The digital filter design apparatus of claim 8, further comprising:
a residual frequency response determination apparatus connected to the high pass filter design apparatus and the noise suppression filter design apparatus, wherein:
the high pass filter design apparatus is arranged to send a filter response portion signal indicative of a part of the desired frequency response that is provided by a selected high pass filter; and
the residual frequency response determination apparatus is arranged to:
receive the filter response portion signal;
determine a residual desired frequency response based on the received filter response portion signal; and
convey a signal indicative of the residual desired frequency response to the noise suppression filter design apparatus.

12. The digital filter design apparatus of claim 8, further comprising:
a residual frequency response determination apparatus connected to the high pass filter design apparatus and the noise suppression filter design apparatus, wherein:
the noise suppression filter design apparatus is arranged to send a filter response portion signal indicative of a part of the desired frequency response that is provided by a selected noise suppression filter; and
the residual frequency response determination apparatus is arranged to:
receive the filter response portion signal from the noise suppression filter design apparatus;
determine a residual desired frequency response based on the received filter response portion signal; and
convey a signal indicative of the residual desired frequency response to the high pass filter design apparatus.

13. A user equipment comprising the digital filter design apparatus of claim 8.

14. A digital filter arrangement for noise suppression of a signal representing an acoustic recording, the filter arrangement comprising;
an input for receiving the signal;
an output for outputting a filtered signal;
a noise suppression filter adapted to filter the received signal in the time domain; and
an adaptive high pass filter arranged in cascade with the noise suppression filter.

15. The filter arrangement of claim 14, wherein characteristics of the high pass filter may be adjusted in response to a desired frequency response of the filter arrangement.

16. The filter arrangement of claim 14, wherein characteristics of the noise suppression filter may be adjusted in response to the frequency response of the high pass filter.

17. The filter arrangement of claim 14, wherein the high pass filter is a first order Butterworth filter.

18. A computer program product for designing a digital filter arrangement for noise suppression of a signal (y(t)) representing an acoustic recording, the computer program product comprising:
computer program code adapted to, based on the received signal, determine a desired frequency response (Hₜₒₜₐₗ(z, ω)) of the digital filter arrangement; and
computer program code adapted to design the filter arrangement to include a high pass filter (h_{HP}(z)) and a noise suppression (h_{NS}(z)) filter; wherein the high pass filter and the noise suppression filter are selected to be applied to the signal in cascade and at least one of the high pass filter and the noise suppression filter is selected based on the determined desired frequency response.
